(19) United States
(12) Patent Application Publication
(10) Pub. No.: US 2017/0300975 A1
(43) Pub. Date: Oct. 19, 2017

(54) METHODS AND SYSTEM FOR LOCATION-BASED TARGETED OFFERS VIA VEHICLE COMMUNICATION SYSTEM

(71) Applicant: MasterCard International Incorporated, Purchase, NY (US)

(72) Inventors: Marianne Iannace, North Salem, NY (US); Patrick Lowery, Catskill, NY (US); Sheridan Benjamin Schechner, Short Hills, NJ (US); Prasad V Iyer, Wilton, CT (US); Lisa Helen Yates, Wildwood, MO (US)

(21) Appl. No.: 15/097,953

(22) Filed: Apr. 13, 2016

(51) Int. Cl. G06Q 30/02

(52) U.S. Cl. CPC G06Q 30/0266; G06Q 30/0234

(57) ABSTRACT

A method includes tracking a location of a motor vehicle that has been registered with a vehicle communication system. Promotional offer information is received. The promotional offer information indicates a promotional offer identified based on a current location of the motor vehicle. The promotional offer information is pushed via the vehicle communication system to an information output device installed in the motor vehicle.

### BACKGROUND

There have been previous proposals for tracking the locations of individuals and presenting advertising messages or promotional offers based on the individuals' current locations. However, such advertising or promotional messages may not be relevant to the individuals' actual interests or preferences or may be poorly timed.

Consequently, previous location-based promotional messaging proposals may be lacking in efficiency and may cause prospective recipients of the messages to lose interest in receiving them.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a functional block diagram representation of a system for providing location-based offers according to aspects of this disclosure.

FIG. 3 is a block diagram representation of the system of FIG. 2 in relation to aspects regarding acceptance and consummation of offers.

FIGS. 4 and 5 are block diagram representations of computer systems that may serve as components of the system of FIGS. 2 and 3.

FIG. 6 is a block diagram representation of a typical vehicle dashboard communication device that may play a role in the system of FIGS. 2 and 3.

FIGS. 7, 8, 9 and 10 are flow charts that illustrate aspects of the present disclosure.

### DETAILED DESCRIPTION

In general, and for the purpose of introducing concepts of embodiments of the present disclosure, a vehicle communication system tracks the location of a motor vehicle driven by an individual who has signed up for location-based offers. The individual's shopping preferences and/or propensities are considered in selecting location-based offers. Timing and current driving conditions are also considered in whether to transmit an offer or offers to the individual. If appropriate under the circumstances, a location-based offer may be communicated to the individual via the vehicle communication system through a dashboard-based communication device. Uptake of the offer may be detected in real time by tracking payment account system transaction messaging. Confirmation of the award of a rebate for the transaction may also be communicated to the individual via the vehicle communication system and the dashboard device. The rebate may be implemented as a credit to the individual's payment account.

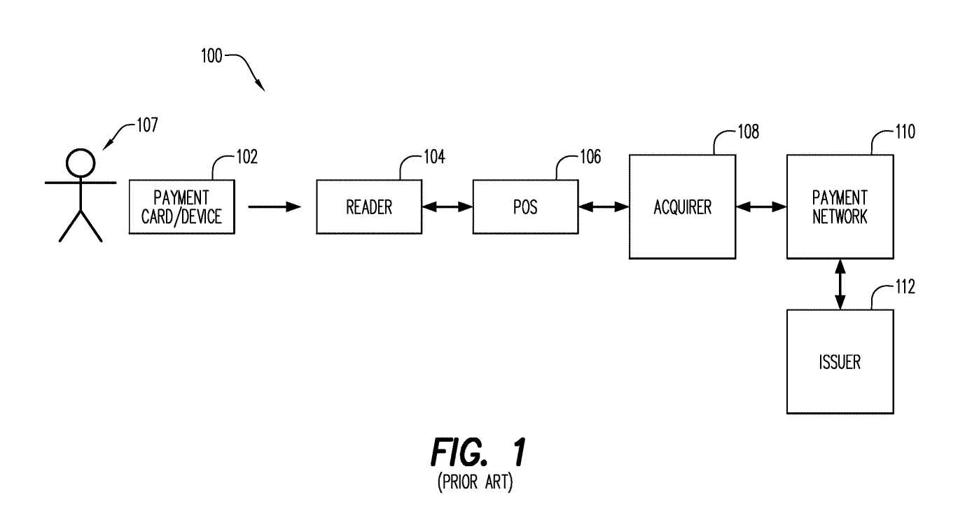

As background to the location-based offer system of the present disclosure, there will initially be a description of a conventional payment system 100, as depicted in FIG. 1.

The system 100 includes a conventional payment card/device 102 (which may alternatively be, for example, a magnetic stripe card, a payment IC card or a payment- enabled mobile device that stores a payment card account number or payment token and runs a payment app). The system 100 further includes a reader component 104 associated with a POS terminal 106. In some known manner (depending on the type of the payment card/device 102) the reader component 104 is capable of reading the payment card account number/token and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction. Reference numeral 107 indicates a user/account holder who is a customer at the retail store and who has presented the payment card/device 102 to the reader component in order to settle the retail transaction.

A computer 108 operated by an acquirer (acquiring financial institution; sometimes referred to as a “transaction acquirer”) is also shown as part of the system 100 in FIG. 1. The acquirer computer 108 may operate in a conventional manner to receive a payment account transaction authorization request message (sometimes referred to as an “authorization request”) for the transaction from the POS terminal 106. The acquirer computer 108 may route the authorization request via a payment network 110 to the server computer 112 operated by the issuer of a payment account that is associated with the payment card/device 102. As is also well known, the payment account transaction authorization response message (also referred to as an “authorization response”) generated by the payment account issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment network 110 may store transaction information contained in the transaction messaging that is routed via the payment network 110.

The payment card issuer server computer 112 may be operated by or on behalf of a financial institution (“FI”) that issues payment accounts to individual users and other entities. For example, the payment account issuer server computer 112 may perform such functions as (a) receiving and responding to requests for authorization of payment account system transactions to be charged to payment accounts issued by the FI; and (b) tracking and storing transactions and maintaining account records.

The components of the system 100 as depicted in FIG. 1 are only those that are needed for processing a single transaction. A typical payment account system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment cards or other devices for initiating payment transactions by presenting an associated payment account number or token to the reader component of a POS terminal.

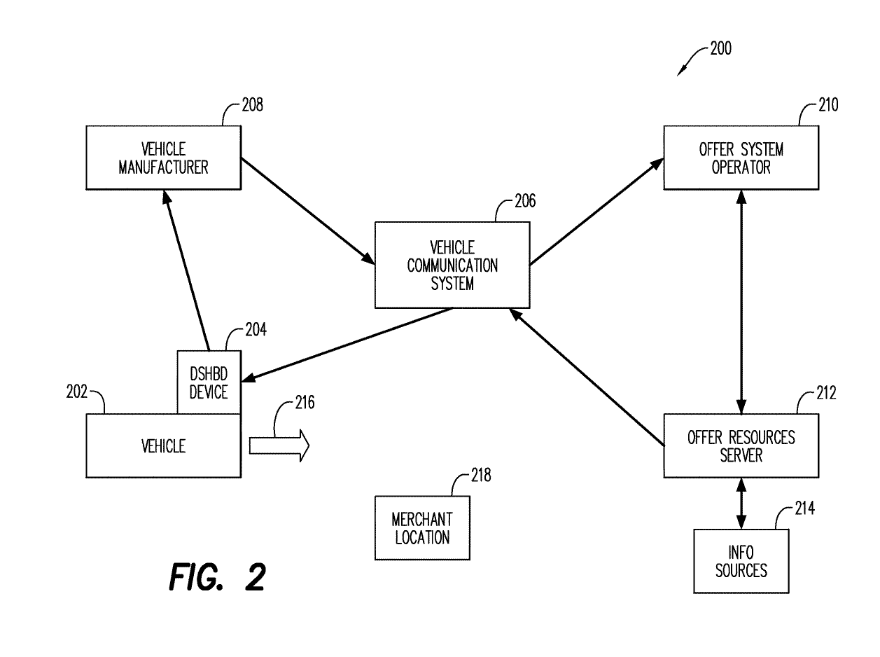

FIG. 2 is a functional block diagram representation of a system 200 for providing location-based offers according to aspects of this disclosure.

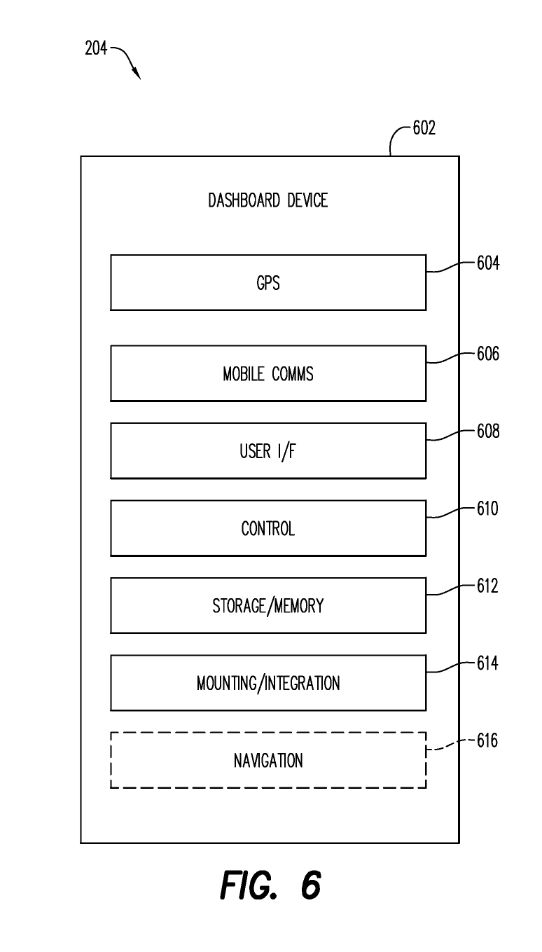

Block 202 in FIG. 2 schematically represents a motor vehicle. Typically, but not necessarily, motor vehicle 202 may be a passenger car. Block 204 represents a communications device that is installed within, in or on the dashboard (not separately shown) of the motor vehicle 202. In some embodiments, dashboard device 204 may resemble or be the type of device that performs the vehicle-based functions of a system such as the well-known “OnStar” system. In other embodiments, the dashboard device 204 may be a GPS-based navigation device mounted on or adjacent to the vehicle dashboard, and modified to have additional communication features to provide functionality as described herein. An example embodiment of the dashboard device 204 will be described in more detail below, including the discussion below related to FIG. 6.

At block 206, a vehicle communication system is indicated. In some embodiments, the vehicle communication system 206 may incorporate features and functionality of the centralized aspects of a system such as the above-mentioned “OnStar” system. In addition, the vehicle communication system 206 may provide functionality to support delivery of location-based offers to the dashboard device 204 in accordance with aspects of the present disclosure.

Block 208 represents the manufacturer of the motor vehicle 202. As is true of other blocks shown in FIG. 2 that represent entities, block 208 also represents one or more computer systems operated by the respective entity (in this case, vehicle manufacturer 208). As will be seen, the vehicle manufacturer 208 may receive a series of signals from the dashboard device 204 to report updates on the current location of the motor vehicle 202, and the vehicle manufacturer 208 may forward the location updates to the vehicle communication system 206.

Although blocks 206 and 208 are portrayed as separate entities/computers, in some embodiments, or at least for some purposes, the two blocks 206 and 208 may represent a single integrated computer system or a system of closely cooperative computers.

In addition to the elements described up to this point in connection with FIG. 2, the system 200 may further include an offer system operator 210. The offer system operator 210 may provide overall coordination and control for the system 200. In some embodiments, the offer system operator 210 may be part of or affiliated with an operator of a payment network such as the payment network 110 shown in FIG. 1. Details of the offer system operator 210 will be described below.

Another component of the system 200 may be an offer resources server computer 212. The offer resources server computer 212 may exchange communications with the offer system operator 210, and may be under common operation with the offer system operator 210. In some embodiments, computer resources for the offer system operator 210 and the offer resources server computer 212 may be integrated and/or combined and/or in close cooperation. The offer resources server computer 212 may store data indicative of potential location-based offers that may be delivered to an audience of drivers according to aspects of the present disclosure. Details of the offer resources server computer 212 will be described below.

Also shown in FIG. 2 is a block 214 that may be present in some embodiments. Block 214 represents potentially real-time sources of information that may be provided to the offer resources server computer 212. As will be seen, the information obtained by the offer resources server computer 212 from the information sources 214 may include current local traffic conditions within one or more metropolitan areas and/or current weather conditions at various locations.

Referring still to FIG. 2, the arrow mark 216 in the drawing is intended to schematically represent progress made by the motor vehicle 202 along a route or itinerary selected by the driver (not shown in FIG. 2) of the motor vehicle 202. Also schematically shown in FIG. 2 is a merchant location 218, which is assumed to be located such that the motor vehicle 202 is approaching the merchant location 218.

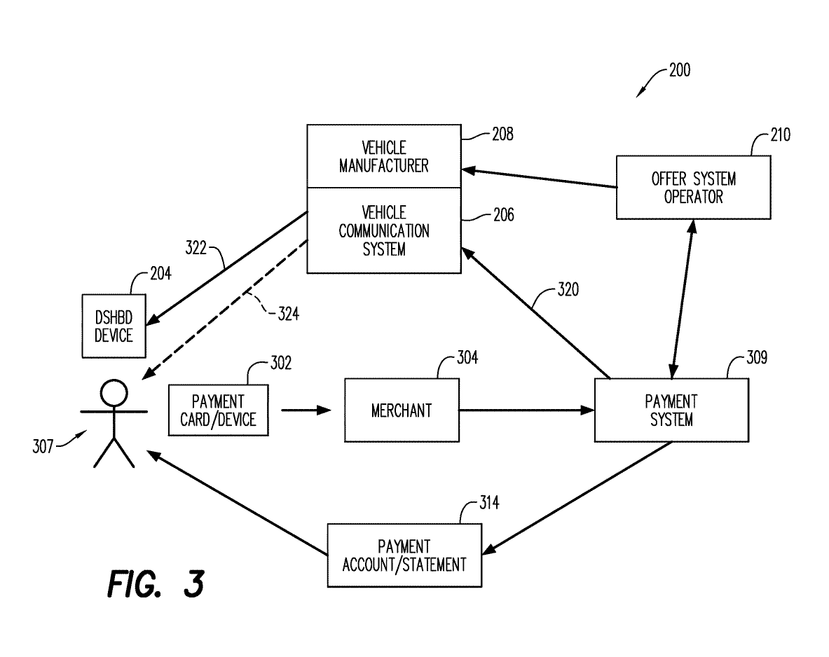

FIG. 3 is a block diagram representation of the system 200 of FIG. 2 in relation to aspects regarding acceptance and consummation of offers.

For purposes of FIG. 3, it is assumed that a location-based offer transmitted to a driver/payment account holder via the dashboard device 204 (FIG. 2, also shown in FIG.3) can be accepted and redeemed simply by entering into a transaction at a nearby merchant 304 (FIG. 3) identified in the offer. (The merchant 304 shown in FIG. 3 may be the operator of the merchant location 218 shown in FIG. 2.) As per elements 107, 102 shown in FIG. 1, the driver/account holder is represented at 307 in FIG. 3, and his/her payment card/device is represented at 302. It is to be understood that the merchant 304 in FIG. 3 may have equipment (corresponding to elements 104, 106 in FIG. 1; not separately shown in FIG. 3) to which the payment/card device 302 is presented to settle a purchase transaction (i.e., the/a transaction proposed in the location-based offer). The transaction is processed via the payment system 309 (FIG. 3; reference is made again to elements 108, 110, 112 of FIG. 1). It is assumed that the offer system operator 210 alerted the payment system 309 that the transaction had been proposed by location-based offer and was to be rewarded with a rebate or the like. The payment network (not shown in FIG. 3 apart from block 309) and/or a computing resource (not shown) associated with the payment network may track network transaction messages for the driver's payment account to detect that the transaction proposed by the offer has occurred (i.e., to detect that the driver 307 has transacted with the merchant 304 in the manner proposed by the offer). The payment system 309 (e.g., the payment account issuer, not separately shown in FIG. 3) may credit the rebate to the account holder's payment account/statement 314. The rebate process may take place virtually in real time, and notification/confirmation of the same may also occur in virtually real time via, e.g., the vehicle communication system 206 and the dashboard device 204 (as illustrated by communication paths 320 and 322. Alternatively, a communication path 324 (shown in phantom) may be employed for the confirmation—e.g., to the account holder's smartphone, which may but need not be the payment card/device 302 (i.e., the account holder's smartphone may be payment-enabled and used for the transaction illustrated in FIG. 3).

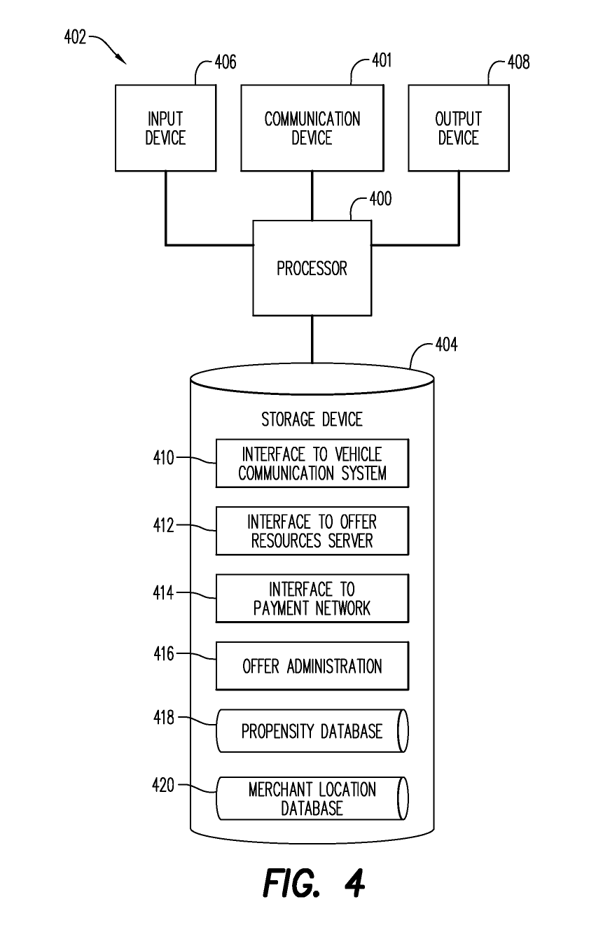

FIG. 4 is a block diagram representation of a computer system that may serve as a component of the system 200 of FIGS. 2 and 3. In particular, FIG. 4 illustrates a system operator computer 402 that may perform some or all of the functions of the offer system operator 210 (FIGS. 2 and 3).

Continuing to refer to FIG. 4, the system operator computer 402 may be constituted by server computer hardware and/or mainframe computer hardware.

The system operator computer 402 may include a computer processor 400 operatively coupled to a communication device 401, a storage device 404, an input device 406 and an output device 408. The communication device 401, the storage device 404, an input device 406 and the output device 408 may all be in communication with the processor 400.

The computer processor 400 may be constituted by one or more processors, including multi-core processing devices. Processor 400 operates to execute processor-executable steps, contained in program instructions described below, so as to control the system operator computer 402 to provide desired functionality.

Communication device 401 may be used to facilitate communication with, for example, other devices (such as the vehicle communication system 206 and the offer resources server computer 212). For example, communication device 401 may comprise numerous communication ports (not separately shown), to allow the system operator computer 402 to communicate simultaneously with the vehicle communication system 206 and the offer resources server computer 212 over numerous communication channels to accommodate retrieval and transmission of numerous offers at any one time, destined for presentation to numerous drivers (represented by one such driver at 307 in FIG. 3) who participate in the system 200.

Continuing still to refer to FIG. 4, input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 404 stores one or more programs for controlling processor 400. The programs comprise program instructions (which may be referred to as computer readable program code means) that contain processor-executable process steps of the system operator computer 402, executed by the processor 400 to cause the system operator computer 402 to function as described herein.

The programs may include one or more conventional operating systems (not shown) that control the processor 400 so as to manage and coordinate activities and sharing of resources in the system operator computer 402, and to serve as a host for application programs (described below) that run on the system operator computer 402.

The programs stored in the storage device 404 may also include a software interface 410 that controls the processor 400 to enable the system operator computer 402 to interact with the vehicle communication system 206. In addition, the programs stored in the storage device 404 may include a software interface 412 that controls the processor 400 to enable the system operator computer 402 to interact with the offer resources server computer 212.

Still further, the storage device 404 may store a software interface 414 that controls the processor 400 to enable the system operator computer 402 to exchange communications with a payment network (e.g., reference numeral 110 in FIG. 1) or another component of the payment system 309 shown in FIG. 3.

Moreover, the storage device 404 may store an application program 416 that provides overall administrative and supervisory functions in connection with initiating and requesting fulfillment of delivery of location-based offers in the system 200. Details of the operation of the offer administration application program 416 will be provided below, including the below discussion of flow charts included herein.

The storage device 404 may also store, and the system operator computer 402 may also execute, other programs, which are not shown. For example, such programs may include communications software and a reporting application. The latter program may respond to requests from system administrators for reports on the activities performed by the system operator computer 402. The other programs may also include, e.g., device drivers, etc.

The storage device 404 may also store a propensity database 418 and a merchant location database 420.

The propensity database 418 may store data indicative of shopping preferences, habits and/or propensities for a population of individuals who are registered in the system 200 to receive location-based offers from the system 200. The data stored in the propensity database 418 may be provided from one or more external commercial sources (not shown) of consumer information and/or may be derived from payment network transaction records and/or from other sources. The data stored in the propensity database 418 may be generated from analysis of actual purchasing histories of the registered individuals and/or may be based on inferences from demographic information concerning the registered individuals.

The merchant location database 420 may store data indicative of the geographic locations of stores belonging to merchants that participate in the system 200.

The storage device 404 may also store one or more other databases (not shown) needed for operation of the system operator computer 402.

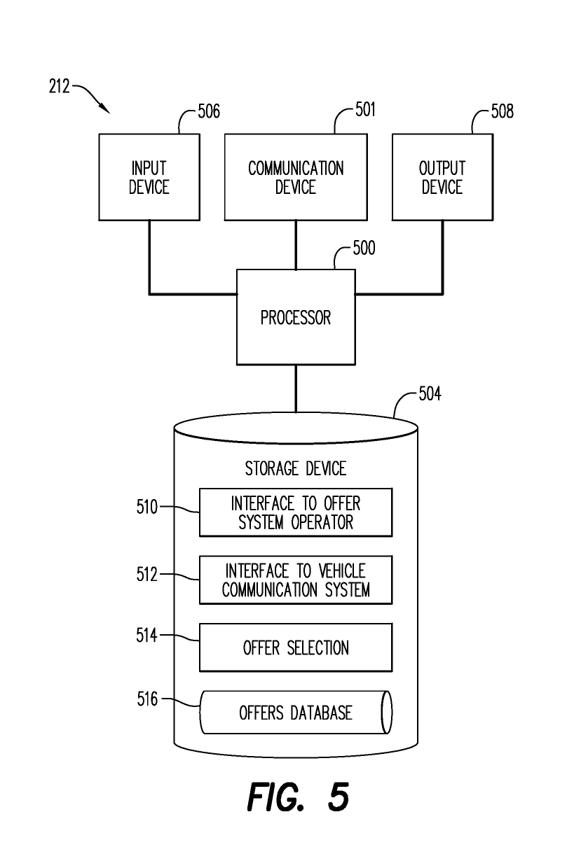

FIG. 5 is a block diagram representation of a computer system that may serve as a component of the system 200 of FIGS. 2 and 3. More specifically, FIG. 5 illustrates an example embodiment of the offer resources server computer 212.

In its hardware architecture and components, the offer resources server computer 212 may, for example, resemble the hardware architecture and components described above in connection with FIG. 4. However, the offer resources server computer 212 may be programmed differently from the system operator computer 402 so as to provide different functionality.

Returning again to the hardware aspects of the offer resources server computer 212, it may include a processor 500, a communication device 501, a storage device 504, an input device 506 and an output device 508. The communication device 501, the storage device 504, the input device 506 and the output device 508 may all be in communication with the processor 500.

The above descriptions of the hardware components shown in FIG. 4 may, in some embodiments, also be applicable to the like-named components shown in FIG. 5.

Storage device 504 stores one or more programs for controlling processor 500. The programs comprise program instructions (which may be referred to as computer readable program code means) that contain processor-executable process steps of the offer resources server computer 212, executed by the processor 500 to cause the offer resources server computer 212 to function as described herein.

The programs may include one or more conventional operating systems (not shown) that control the processor 500 so as to manage and coordinate activities and sharing of resources in the offer resources server computer 212, and to serve as a host for application programs (described below) that run on the offer resources server computer 212.

The programs stored in the storage device 504 may include a software interface 510 that controls the processor 400 to support interactions between the offer resources server computer 212 and the system operator computer 402. The storage device 504 may also store a software interface 512 that controls the processor 500 to enable data communication between the offer resources server computer 212 and the vehicle communication system 206 (FIG. 2). As will be seen, via the interface 512, the offer resources server computer 212 may transmit to the vehicle communication system 206 location-based offers to be presented in real time and en route to users/drivers registered with the system 200.

Further, the storage device 504 may store an order selection application program 514 that controls the processor 500 to enable the offer resources server computer 212 to select available location-based offers in response to messaging from the system operator computer 402. Still further, the storage device 504 may store a database 516 of such offers. There are a number of ways in which currently available location-based offers may come to be stored in the offers database 516. For example, the offer system operator 210 (FIG. 2) may enter into promotional arrangements with various merchants/promotional partners to cause location-based offers from the merchants/promotional partners to be included in the offers database 516. In addition, or alternatively, merchants may be directly enabled to upload location-based offers into the database 516, even in the absence of a formal agreement with the offer system operator 210. For example, merchants may be permitted to access a website (not shown) and to agree to standard terms and conditions on the website to allow for inclusion of their location-based offers in the offers database 516. As another alternative or potentially additional mode of adding offers to the offers database 516, the offer resources server computer 212 may search the World Wide Web to locate and “scrape” offers posted on merchants' websites. The “scraped” offers may then be included in the offers database.

Continuing to refer to FIG. 5, the storage device 504 may also store, and the offer resources server computer 212 may also execute, other programs, which are not shown. For example, such programs may include a reporting application, which may respond to requests from system administrators for reports on the activities performed by the offer resources server computer 212. The other programs may also include, e.g., device drivers, database management programs, communication software, website hosting software, etc. The storage device 504 may also store one or more additional databases (not shown) that may be required for operation of the offer resources server computer 212.

At least some of the other entities shown in FIGS. 2 and 3 may also operate a computer or computers. Those computers should be considered to be represented by the corresponding blocks labeled to represent the respective entities. One or more of the computers may be similar in their hardware components and architecture to the computers depicted in FIGS. 4 and 5.

FIG. 6 is a block diagram representation of an example embodiment of a typical dashboard device 204 (seen in FIGS. 2 and 3).

Reference numeral 602 in FIG. 6 indicates a housing that may contain and/or support other components of the dashboard device 204. In some embodiments, however, the dashboard device 602 may lack a dedicated housing per se, but rather may be incorporated in and supported by the dashboard of the motor vehicle 202 (FIG. 2).

Continuing to refer to FIG. 6, block 604 represents GPS (Global Positioning System) functionality of the dashboard device 204. Block 606 represents mobile communications capabilities of the dashboard device 204. Block 608 represents the user interface (encompassing input and/or output devices) of the dashboard device 204.

Block 610 represents a control unit or circuit (e.g., one or more processors) that controls overall operation of the dashboard device 204. Block 612 represents program and/or working memory and/or other data and/or program storage devices. Memory/storage device(s) 612 may be in communication with the control unit 610 and may program the control unit to cause the dashboard device 204 to provide functionality as described herein.

Block 614 represents one or more structural components and/or fasteners, etc. that allow the housing 602/dashboard device 204 to be mounted in or on and/or integrated with the dashboard of the motor vehicle 202 (FIG. 2).

In some embodiments, the dashboard device 204 may also feature more-or- less conventional navigation functionality (block 616) by which the dashboard device 204 may operate to guide the driver to a location selected by the driver.

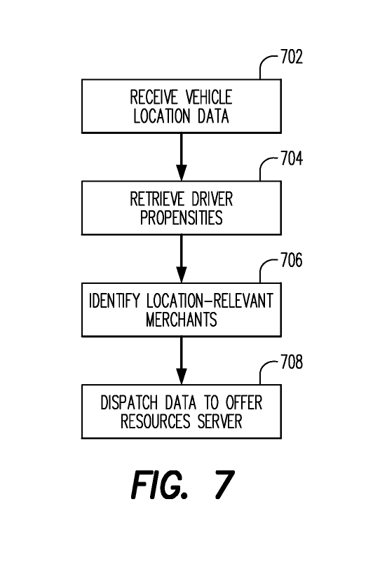

FIG. 7 is a flow chart that illustrates an operation that may be performed in the system 200 according to aspects of the present disclosure. In particular, the process of FIG. 7 may represent functions performed by the offer system operator 210 (FIGS. 2 and 3).

Referring, then, to FIG. 7, at 702 the offer system operator 210 may receive data indicative of the current location of the motor vehicle 202. The data may be received by the offer system operator 210 from the vehicle communication system 206. The data may have originated from the GPS function of the dashboard device 204 and may have been relayed to the vehicle communication system 206 via the vehicle manufacturer 208.

At 704, the offer system operator 210 may retrieve data relating to the shopping propensities, preferences and/or shopping history of the driver of the motor vehicle 202. In some embodiments, the driver may have been identified based on identification data from the dashboard device 204. In some embodiments, the driver identification data may be in hashed form to protect the privacy of the driver. In some embodiments, the hashing of the identification data may utilize services of a third party such that no other party has the driver's identity directly available. In some embodiments, the driver may be identified by an identification number or string assigned to the driver in connection with the location-based offer system 200. In some embodiments, the driver may be identified by his/her payment account number.

At 706, the offer system operator 210 may identify one or more relevant merchants based on the driver's current location. For example, the relevant merchant(s) may be those that are (a) participants in the system 200; (b) match one or more of the driver's shopping propensities; and (c) have a location within a 10 minute drive of the driver's current location. Other considerations or sets of considerations may be used to identify relevant merchants, in other embodiments. For example, a degree of proximity other than being within a 10 minute drive may be used (i.e., greater or lesser proximity).

At 708, the offer system operator 210 may transmit data concerning the identified merchant(s) to the offer resources server computer 212 (FIG. 2). In some embodiments, the offer system operator 210 may also transmit further information to the offer resources server computer 212. This further information may include, for example, the current location of the driver and at least a summary of the driver's shopping propensities/preferences/history. The further information may also or alternatively include store operating hours for the nearby location(s) of the “relevant” merchants' stores.

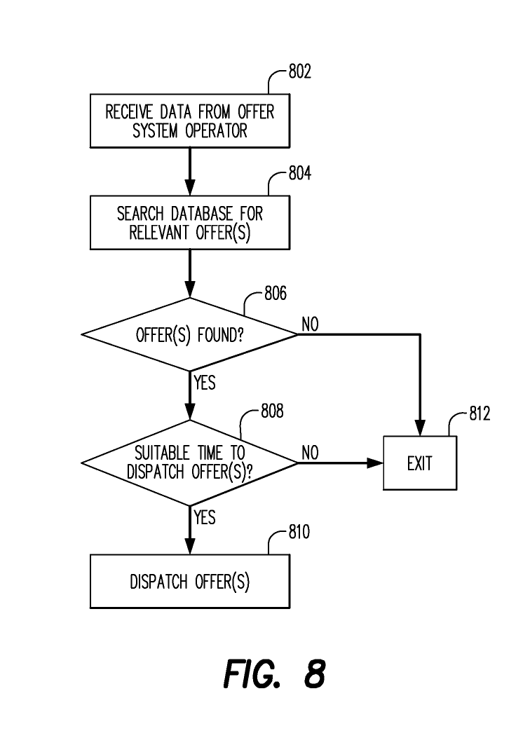

FIG. 8 is a flow chart that illustrates another operation that may be performed in the system 200 according to aspects of the present disclosure. In particular, the process of FIG. 8 may be performed by the offer resources server computer 212.

In FIG. 8, at 802, the offer resources server computer 212 may receive the “relevant merchant” data transmitted to the offer resources server computer 212 from the offer system operator 210 at 708 in FIG. 7.

Continuing to refer to FIG. 8, at 804, the offer resources server computer 212 may search a database it stores to determine whether offers are currently available for the “relevant merchant(s)”. At decision block 806, the offer resources server computer 212 may determine whether any such offers are available. If so, then decision block 808 may follow decision block 806. At decision block 808, the offer resources server computer 212 may determine whether the present time is a suitable time for dispatching one or more of the available offers to the driver.

In making the determination at decision block 808, the offer resources server computer 212 may take a number of different factors into account. For example, the offer resources server computer may consider current driving conditions and/or weather conditions at the driver's current location. The offer resources server computer 212 may have such information available to it from one or more information sources 214 shown in FIG. 2. To give one example, the determination made at decision block 808 may be based on safety concerns, such that the offer resources server computer 212 may determine not to dispatch any offers at times when the driving conditions are difficult (due to weather or traffic or both) at the driver's location at the current time. On the other hand, when the traffic is light and the weather is good at the driver's current location, the offer resources server computer 212 may determine that it is currently a suitable time to dispatch one or more location-based offers to the driver.

Other factors may also enter into the determination at decision block 808. For example, if the offer(s) available only relate(s) to a merchant location or locations that is (are) currently closed, the offer resources server computer 212 may determine that the current time is not suitable for dispatching the offer(s). Moreover, if—for example—there is only one available offer, and it relates to a discount of $5.00 on purchase of a dinner meal at a nearby restaurant, the offer resources server computer may determine that the current time is not suitable for dispatching the offer if it is currently morning or early afternoon at the driver's location.

In some situations, a location-based offer may have been identified that is suitable for sending to the driver, but it may be considered best to hold the offer for a short period of time before sending it to the driver. For example, it may be determined that it is advisable to wait until the vehicle location is somewhat closer to the merchant location before dispatching the offer. By the same token, it may be determined that the offer should not be dispatched until a short time later in order to detect that the driver has not turned off from the route that would take the motor vehicle 202 towards the merchant location. In order to aid in the determinations by the offer resources server computer 212 in relation to these questions, the offer resources server computer 212 may request from, and receive from, the offer system operator 210 ongoing updates as to the current location of the motor vehicle 202.

If a positive determination is made at decision block 808 (i.e., if the offer resources server computer 212 determines that it is currently a suitable time to dispatch one or more location-based offers to the driver), then block 810 may follow decision block 808 in the process of FIG. 8.

At block 810, the offer resources server computer 212 may dispatch one or more location-based offers to the driver. In some embodiments, block 810 may involve the offer resources server computer 212 making a selection among available offers to determine which of the available offers to dispatch to the driver. In some embodiments, the determination of which offer or offers to select may be based on a number of factors. For example, the factors may include one or more shopping propensities or the like that have been determined with respect to the driver. The factors may also or alternatively include one or more scores that have been assigned to the offers such that a higher score indicates that a given offer may be more likely to be accepted and/or may be more profitable and/or may result in a higher fee to be paid to the operator of the system 200. In some embodiments external conditions may be taken into account. For example, the current weather conditions at the driver's location may be taken into account. (As an example of this, if it is currently a warm summer day at the driver's location, and an offer of a rebate on a cold drink is one of the currently available and suitable offers, then the cold drink offer may be selected by the offer resources server computer 212 based on the warm weather conditions in effect at the driver's location.)

In some embodiments, the offer resources server computer 212 may be programmed to be rather selective in dispatching offers to the driver. For example, the offer resources server computer 212 may be programmed with a rule that prevents it from sending two offers to the driver within a short time interval. As another example rule that may be in effect, the offer resources server computer 212 may be prevented from sending more than two offers per hour to the driver, regardless of the number and suitability of available offers. It may be desirable to limit the number of offers dispatched to the driver to attempt to avoid annoying or distracting the driver with an excessive number of offers.

Referring again to decision blocks 806 and 808, if a negative determination is made at either of those decision blocks, the process of FIG. 8 may end without a location-based offer having been dispatched to the driver. Such a conclusion to this process is indicated by the branches to block 812 (“exit”).

It is worth noting that the offer system operator 210 and the offer resources server computer 212 are illustrated as separate blocks in FIG. 2, but nevertheless—in some practical embodiments of the system 200—those two blocks may be functionally integrated and/or partially or completely integrated in hardware terms. Thus one computer or a group of closely linked computers may perform the functions ascribed to blocks 210 and 212 herein.

It should also be understood that if a location-based offer is dispatched to the driver as per block 810 in FIG. 8, suitable messaging may occur from the offer resources server computer 212 via the vehicle communication system 206 (FIG. 2) to the dashboard device 204, such that the offer is visually and/or audibly presented to the driver of the motor vehicle 202 by the dashboard device 204.

In some embodiments, the dashboard device 204 may have a conventional touchscreen display and a speaker, and may visually and audibly present the offer to the driver in terms such as “One dollar off a latte at the Coffee Spot store 3 blocks ahead—touch here for directions!” If at this point the driver touches on the pop-up on the screen, then navigation directions to the merchant store may be provided by the dashboard device 204. (In some embodiments, the driver's touch on the screen may also result in communications back to the offer system operator 210, to indicate the driver's engagement with the offer and to set in motion administrative steps to aid in the execution of the offer. In other embodiments, the only result may be the dashboard device's presentation of navigation instructions, and all necessary administrative steps, as described below, may have been set in motion by the dispatching of the location-based offer, with uptake of the offer to be detected by detecting a transaction between the driver and the relevant merchant, as also described below.)

In other embodiments, where the dashboard device is—or is associated with—a navigation device, the offer may be presented merely as a pop-up on the display of the navigation device.

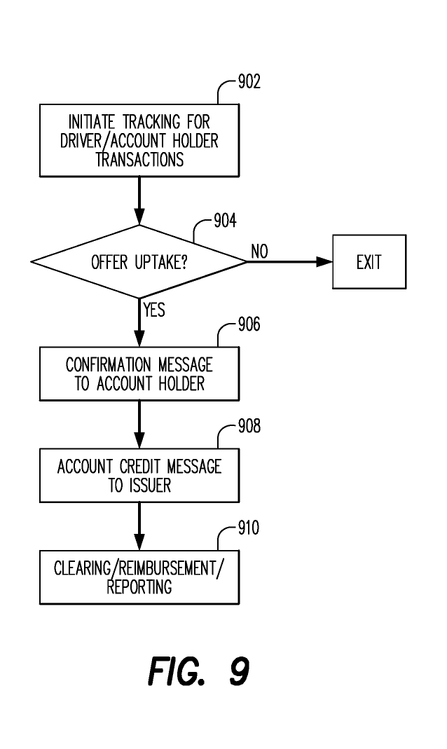

FIG. 9 is a flow chart that illustrates another operation that may be performed in the system 200. The functions illustrated in FIG. 9 may be performed by the offer system operator 210, the offer resources server computer 212, or by those two elements working together, or may be divided between the two elements.

At 902 in FIG. 9, the offer system operator 210 (say) may communicate with an element of the payment system 309 (FIG. 3) to indicate that the transaction message traffic should be scanned to detect whether the driver's payment account is used to engage in a transaction that accepts/consummates the location-based offer(s) dispatched at 810 in FIG. 8. The element in question may be a computer (not shown apart from block 309 in FIG. 3) that is, for example, associated with a payment network such as element 110 in FIG. 1. Such a computer may, for example, be at least partially integrated with and/or under common operation with the offer system operator 210, the offer resources server computer 212 and/or a payment network. Step 902 may be undertaken in response to messaging from the offer resource server computer 212, or directly by the latter computer.

In some embodiments, the offer may be available for acceptance for only a limited amount of time (say one hour), and the tracking process of block 902 may last for that period of time and no longer.

Decision block 904 may follow block 902 in the process of FIG. 9. At decision block 904, it is determined whether the driver (reference numeral 307 in FIG. 3) has engaged in a transaction (using his/her payment card/device 302) that results in acceptance of the location-based offer dispatched at 810 in FIG. 8. This determination may be based for example on the presence or absence of a notification from the payment system 309 (FIG. 3) that indicates that such a transaction occurred. If a positive determination is made at decision block 904 (FIG. 9), then block 906 may follow decision block 904.

At block 906, a message may be forwarded to the driver to confirm that the driver has received or will receive a rebate or other benefit as specified in the location-based offer. The message may proceed via communication paths 320 and 322 or 324 in FIG. 3 (and thus via the vehicle communication system 206), for delivery to the driver 307 via the dashboard device 204 or by another device such as the driver's smartphone (not necessarily shown in FIG. 3). It may prove to be a favorable marketing strategy to inform the driver in real time of the reward/benefit/rebate he/she just earned by accepting the location-based offer, because this immediate notification may encourage the driver to accept further offers.

At 908 in FIG. 9, a message is sent to the issuer of the driver's payment system account to cause the account to be credited by the amount of the rebate. This message may come from one or more of a computer associated with the relevant payment network, the offer system operator 210 and the offer resources server computer 212. It will be appreciated that this credit will appear on the driver's account statement (block 314, FIG. 3) and thereby may be reported a second time to the driver 307.

Block 910 includes clearing, reimbursement and/or reporting relative to the rebate and/or the accepted location-based offer. For example, as part of the processing in block 910, the issuer of the driver's payment system account may receive reimbursement (e.g., via a clearinghouse, which is not shown) from the merchant that made the offer/rebate. Moreover, the offer system operator 210 (FIG. 3) may provide batch-based reporting to the vehicle manufacturer 208 and/or the vehicle communication system 206 to report on the effectiveness of the offer program (i.e., how many offers were made through the system 200, how many were accepted by the universe of driver-participants, how much compensation the vehicle manufacturer and/or the vehicle communication system 206 may be entitled to for providing/supporting the promotional communication channel to the universe of driver-participants). This stage of the process may also involve payment to the vehicle manufacturer and/or the vehicle communication channel for providing the communication channel for the location-based offers. In some embodiments, the amount of payment may be directly or partially related to the number of offers accepted.

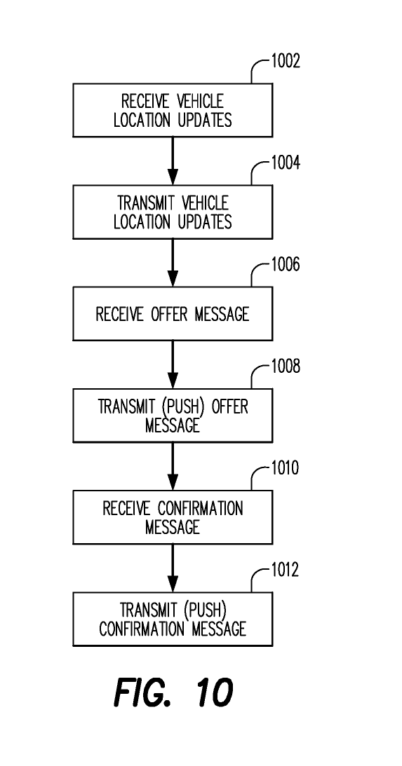

FIG. 10 is a flow chart that illustrates other operations that may be performed in the system 200. More specifically, the functions shown in FIG. 10 may be performed by the vehicle communication system 206 (FIGS. 2 and 3).

Referring now to FIG. 10, at 1002 the vehicle communication system 206 may receive data messages that reflect location updates with respect to the motor vehicle 202. These messages may be received from the dashboard device 204. At 1004, the vehicle communication system 206 may transmit corresponding location update messages. For example the vehicle communication system 206 may relay the updates to the offer system operator 210.

At 1006, the vehicle communication system 206 may receive a message that indicates one of the above-mentioned location based offers. The offer may have been dispatched to be delivered to the driver of the motor vehicle 202 via the dashboard device 204. The offer message may have been transmitted to the vehicle communication system 206 from the offer resources server computer 212.

At 1008, the vehicle communication system 206 may transmit or “push” the offer message to the dashboard device 204.

At 1010, the vehicle communication system 206 may receive a message (as per block 906, FIG. 9) intended to confirm to the driver that he/she has just earned/been credited with a rebate or other reward.

At 1012 in FIG. 10, the vehicle communication system 206 may transmit or “push” the confirmation message received at 1010 for presentation to the driver 307 (FIG. 3) via the dashboard device 204 or via another device, as discussed above.

A location-based offer system as described above may be a highly efficient mode of delivering marketing messages, by leveraging the existing infrastructure of vehicle communication systems and their corresponding terminal devices (dashboard devices) installed in large numbers of motor vehicles. Efficiency of the system may be further promoted by its association with and leveraging of payment system transaction messaging. Furthermore, the location-based offers presented to drivers/participants according to this system are likely to be of interest to, and accepted by, the drivers/participants at a rather high rate, because the offers have been selected on the basis of the drivers'/participants' shopping habits and/or propensities, etc.

Reference has been made herein to drivers/account holders registering with the system 200 to receive location-based offers therefrom. In the registration process, the driver's payment account number or numbers may be associated with the motor vehicle/dashboard device operated by the driver.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

As used herein and in the appended claims, the term “information output device” refers to the dashboard device 204 in any of its various embodiments as described herein and/or to a mobile device such as a smartphone.

The flow charts and descriptions thereof herein should not be understood to prescribe a fixed order of performing the method steps described therein. Rather the method steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account”, “payment card account”, “payment account” and “payment system account” are used interchangeably herein. The term “payment card account number” includes a number that identifies a payment card system account or a number carried by a payment card, or a number that is used to route a transaction in a payment system that handles payment card transactions. The term “payment card” includes a credit card, debit card, prepaid card, or other type of payment instrument, whether an actual physical card, electronic, or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
tracking a location of a motor vehicle that has been registered with a vehicle communication system;
receiving promotional offer information indicative of a promotional offer identified based on a current location of the motor vehicle; and
pushing the received promotional offer information via the vehicle communication system to an information output device installed in the motor vehicle;
wherein the promotional offer is selected based at least in part on a spend propensity associated with a driver of the motor vehicle.

2. The method of claim 1, wherein said tracking, receiving and pushing steps are performed by a computer operated by the vehicle communication system.

3. The method of claim 2, further comprising:
prior to said receiving step, transmitting from said computer, to a source of said promotional offer information, data indicative of said tracked location.

4. The method of claim 3, further comprising:
after said pushing step, receiving a confirmation message indicating that an operator of the motor vehicle accepted the promotional offer.

5. The method of claim 4, wherein the confirmation message is a first confirmation message;
the method further comprising:
after the second receiving step, pushing a second confirmation message to the information output device.

6. The method of claim 1, wherein the tracking step includes:
receiving a sequence of messages from a vehicle manufacturer, the sequence of messages being location updates with respect to the motor vehicle.

7. The method of claim 1, wherein a promotional offer represented by the promotional offer information is an offer of a rebate to be credited to an operator of the motor vehicle in return for the operator engaging in a transaction with a business establishment that the motor vehicle is approaching at the time of performing the pushing step.

8. The method of claim 7, wherein the promotional offer includes a name of the business establishment.

9. The method of claim 8, wherein the promotional offer indicates a monetary amount that corresponds to the rebate.

10. The method of claim 9, wherein the promotional offer specifies the transaction.

11. A method comprising:
dispatching a location-based promotional offer addressed to a motor vehicle;
receiving at least one transaction message representing a transaction engaged in by an individual to accept the promotional offer; and
in response to the at least one transaction message, sending a confirmation message for delivery to the individual via the motor vehicle, the confirmation message confirming that the individual's payment system account has been credited with a rebate in regard to the transaction.

12. The method of claim 11, wherein the individual is an operator of the motor vehicle.

13. The method of claim 11, further comprising:
prior to the dispatching step, associating the individual's payment system account with the motor vehicle.

14. The method of claim 11, wherein the promotional offer is dispatched for delivery to the motor vehicle via a vehicle communication system.

15. The method of claim 11, further comprising:
crediting the rebate to the individual's payment system account.

16. The method of claim 15, wherein the crediting step includes transmitting a message to an issuer of the individual's payment system account.

17. The method of claim 16, further comprising:
receiving reimbursement for the rebate from a merchant with which the transaction was performed.

18. The method of claim 11, wherein the at least one transaction message includes at least one of a transaction authorization request message and a transaction authorization response message.

19. The method of claim 11, wherein the location-based promotional offer is selected based at least in part on a spend propensity associated with said individual.

20. A method comprising:
providing a navigation device installed at a dashboard of a motor vehicle; and
displaying a location-based promotional offer on the navigation device;
wherein the location-based promotional offer is selected based at least in part on a spend propensity associated with a driver of the motor vehicle.

21. The method of claim 20, wherein the promotional offer is presented in conjunction with a business establishment that is being approached by the motor vehicle at a time when the displaying step is being performed.
